(19) United States
(12) Patent Application Publication
(10) Pub. No.: US 2026/0178626 A1
(43) Pub. Date: Jun. 25, 2026

(54) Virtual Batches in Large Language Model Inferences

(71) Applicant: Google LLC, Mountain View, CA (US)

(72) Inventor: Michael Christian Butler, Sunnyvale, CA (US)

(73) Assignee: Google LLC, Mountain View, CA (US)

(21) Appl. No.: 19/425,506

(22) Filed: Dec. 18, 2025

Related U.S. Application Data
(63) Continuation of application No. PCT/US2024/062418, filed on Dec. 31, 2024.
(60) Provisional application No. 63/737,526, filed on Dec. 20, 2024.

(51) Int. Cl. G06F 16/3329

(52) U.S. Cl. CPC G06F 16/33295

(57) ABSTRACT

This document describes systems and techniques directed at virtual batches in large language model (LLM) inferences. An LLM, at least partially deployed on an electronic device, generates a dependency map for a plurality of inference tokens. The inference tokens can be based on a same input, different inputs, or a mixture of both. The dependency map indicates sequential or otherwise logical dependence of each inference token. The LLM can further generate a plurality of virtual batches based on the dependency map. The plurality of virtual batches includes masked portions indicating positions in one or more of the plurality of virtual batches that do not have an active token reference.

### CROSS-REFERENCE TO RELATED APPLICATIONS

This application is a continuation of and claims priority to U.S. Non-Provisional Patent Application Ser. No. PCT/US2024/062418, filed Dec. 31, 2024, which in turn claims the benefit of U.S. Provisional Patent Application Ser. No. 63/737,526, filed Dec. 20, 2024, the disclosures of which are incorporated by reference herein in their entireties.

### BACKGROUND

Large language models (LLMs) provide predictive outputs (“inferences”) based on parsing an input, such as a user text input, an audio input, a video input, an image input, etc. The inferences are sequentially generated, meaning each prediction fragment (“token”) proceeds from the prior token. This does not allow for inference optimization, which has led to the use of batches in inferences. Batches are concurrently generated inferences which can be based on a common input, disparate inputs, or a combination of both. Each batch represents a discrete inference from the LLM. Multiple inference batches are computationally expensive, making batch-inferencing LLMs cumbersome or impossible to deploy on consumer computing devices.

### SUMMARY

This document describes systems and techniques directed at virtual batches in large language model (LLM) inferences. An LLM, at least partially deployed on an electronic device, generates a dependency map for a plurality of inference tokens. The inference tokens can be based on a same input, different inputs, or a mixture of both. The dependency map indicates sequential or otherwise logical dependence of each inference token. The LLM can further generate a plurality of virtual batches based on the dependency map. The plurality of virtual batches may include masked portions indicating positions in one or more of the plurality of virtual batches that do not have an active token reference.

In aspects, an electronic device is disclosed, the electronic device including one or more processors and a memory storing instruction. The instructions, when accessed by the one or more processors, cause the one or more processors to generate, using an LLM, a dependency map for a plurality of tokens. The dependency map includes one or more index markers for each of the plurality of tokens and a correlation marker for each of the one or more index markers. The instructions further cause the one or more processors to generate, based on the dependency map, a plurality of virtual batches, each of the plurality of virtual batches including a discrete inference, and select one or more of the plurality of virtual batches as a final inference.

In aspects, a method is disclosed that includes generating, with an LLM, a plurality of tokens. The method further includes generating, by the LLM, a dependency map including one or more index markers for each of the plurality of tokens and a correlation marker for each of the one or more index markers. The method further includes generating, based on the dependency map, a plurality of virtual batches, each of the plurality of virtual batches including a discrete inference. The method further includes selecting, by the LLM, one or more of the plurality of virtual batches as a final inference.

In aspects, a non-transitory, computer-readable medium is disclosed, the non-transitory, computer-readable medium including instructions that, when accessed by one or more processors, cause the one or more processors to generate, using an LLM, a plurality of tokens. The method further includes generating, by the LLM, a dependency map. The dependency map includes one or more index markers for each of the plurality of tokens and a correlation marker for each of the one or more index markers. The instructions further cause the one or more processors to generate, based on the dependency map, a plurality of virtual batches, each of the plurality of virtual batches comprising a discrete inference, and select one or more of the plurality of virtual batches as a final inference.

In aspects, a computer programming product is disclosed, the computer programming product including a memory storing instructions that, when accessed by one or more processors, cause the one or more processors to generate, using an LLM, a plurality of tokens. The instructions further cause the one or more processors to generate a dependency map. The dependency map includes one or more index markers for each of the plurality of tokens and a correlation marker for each of the one or more index markers. The instructions further cause the one or more processors to generate, based on the dependency map, a plurality of virtual batches, each of the plurality of virtual batches comprising a discrete inference, and select one or more of the plurality of virtual batches as a final inference.

This Summary is provided to introduce simplified concepts for virtual batches in large language model inferences, which are further described below in the Detailed Description and are illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for virtual batches in large language model inferences are described in this document with reference to the following drawings:

FIG. 1 illustrates an example environment in which techniques for virtual batches in large language model inferences can be implemented;

FIG. 2 illustrates an example of an electronic device of FIG. 1 for implementing virtual batches in large language model inferences;

FIGS. 3A-3C illustrate an example dependency map array for implementing virtual batches in large language model inferences;

FIGS. 4A-4D illustrates an example virtual batch generation with masking;

FIG. 5 illustrates an example trainer for an LLM, such as one used in virtual batches in large language model inferences;

FIG. 6 illustrates an example transformation in a language space of an input tensor component;

FIG. 7 illustrates an example method for implementing virtual batches in large language model inferences.

The use of same numbers in different instances may indicate similar features or components.

### DETAILED DESCRIPTION

### Overview

The promulgation of artificial intelligence (AI), particularly large language models (LLMs), has revolutionized personal digital assistance, automation, novel code generation, and other areas of modern computing. The development of LLM use cases has resulted in a need for better predictions and inferences from LLMs. Traditionally, an LLM parses an input prompt and produces an output (prediction, inference, etc.). One way to improve the output of the LLM is to generate multiple inferences/outputs from one or more inputs (one or more text inputs, one or more image inputs, a mixture of text and image inputs, etc.). Each of the multiple inferences can be discrete, resulting in a plurality of inferences from which the LLM can choose as a final inference/output. In some cases, each of the plurality of inferences includes the one or more inputs. However, this methodology results in a much higher computational cost than simply generating a single inference/output. This increased computational cost (processor time/cycles, memory usage, cache usage, etc.) can prove prohibitive on many electronic devices (mobile electronic devices, smartphones, virtual reality (VR) or augmented reality (AR) goggles, smart watches, etc.).

With the increased utility and functionality of LLMs, relegating more robust embodiments (e.g., the LLM employing multiple batches for inference generation) to higher-resource computing devices denies most users from leveraging the increased capabilities of modern LLMs. For example, an LLM including generating multiple inference batches that, due to the computational cost of generating and maintaining the multiple inference batches, can only be deployed on a server and may not be fully accessible to a user with a smartphone that is not connected to the server. In another example with the LLM including generating multiple inference batches that can only be deployed on the server, the user with the smartphone can connect to the server, but the increased processing time/computational cost over a traditional LLM can result in a poor user experience, a drop in functionality, or other undesirable outcomes. In some instances, the act of generating and/or parsing multiple inference batches becomes overly computationally costly before sufficient advantage can be realized over traditional LLM processing.

This document describes techniques and systems for virtual batches in large language model inferences. The techniques and systems use a generated dependency map to order and relate a plurality of tokens. A plurality of virtual batches is generated based on the dependency map. Each of the plurality of virtual batches represents, in aspects, a discrete inference. The LLM selects one or more of the plurality of virtual batches as a final prediction. In aspects, the final prediction is configured for output.

Tokens, as referred to in this disclosure, represent inference tokens generated by the LLM. In some examples, the tokens are in a text form (e.g., a word, a part of grammar, a word fragment). In some examples, the tokens are a mathematical construct (e.g., a tensor) in a language space. In aspects, the tokens can be referred to as embeddings. In some examples, the input is not a text input (a sound input, an image input, etc.). In such examples, the tokens can be soft tokens. In some examples, soft tokens are tokens that are embedded but at least in part dynamic. In some examples, soft tokens are tokens that have additional labels, tags, information, etc.

The generation of the dependency map, in aspects, uses fewer computational resources than generating separate, physical batches. For example, a plurality of physical batches each occupy space on a memory, such as a cache memory, which is of a finite size. Virtual batches, in some examples, include a single physical batch. The single physical batch occupies less cache space than were it to be separated into several physical batches. In some examples, the dependency map includes more than one physical batch, but at least one of the more than one physical batches includes more than one virtual batch and still represents a savings in resources.

According to some examples, the virtual batches are not generated by construction but rather are logically extrapolated from the dependency map. In this way, the dependency map can still leverage the advantage of multiple inferences without simultaneously incurring the resource/computational cost of using multiple inferences. Advantages of employing virtual batches in LLM inferences include lower computational cost, lower memory usage, and the ability to deploy a multiple-inference model on less resource-heavy devices, such as a smartphone.

### Operating Environment

The following discussion describes operating environments, techniques that may be employed in the operating environments, and various devices or systems in which components of the operating environments can be embodied. In the context of the present disclosure, reference is made to the operating environments by way of example only.

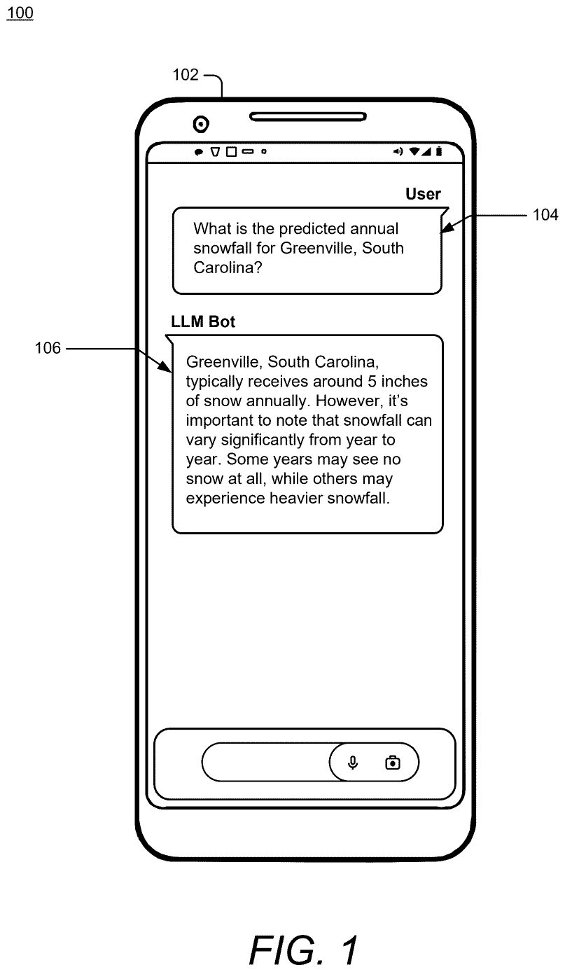

FIG. 1 illustrates an example environment 100 in which techniques for virtual batches in large language model inferences can be implemented. Generally, the environment 100 includes an electronic device 102. The electronic device 102 in the example pictured is a smartphone, though it should be noted that other electronic devices can be used equivalently. The electronic device 102 includes an instantiated LLM (not pictured). An input can be given to the LLM, such as an input prompt 104. The input prompt 104 is illustrated in FIG. 1 as a user input prompt, but according to some examples it can be the product of a machine or machine algorithm. The input prompt 104 is illustrated as a text input, but other input types may be used equivalently (audio, video, image, etc.). The LLM, in aspects, can provide a response 106.

The electronic device 102, in some examples, can be an assistant device (e.g., Google® Nest® Hub; Google® Nest® Hub Max), a home automation controller (e.g., controller for an alarm system, thermostat, lighting system, door lock, motorized doors, etc.), a gaming device (e.g., a gaming system, gaming controller, data glove, etc.), a communication device (e.g., a smart phone such as a Google® Pixel® Phone, cellular phone, mobile phone, wireless phone, portable phone, radio telephone, etc.), a wearable device (e.g., smart watch, smart glasses, earbuds, smart helmet, VR headset, AR goggles, smart ring, etc.), a vehicle (car, electric scooter, automated vehicle, etc.), and/or another computing device (e.g., a tablet computer, phablet computer, notebook computer, laptop computer, etc.). As another example, the electronic device 102 with an assistant application or program (e.g., the AI assistant) may audibly convey information to a user. In some implementations, a battery management system audibly conveys notification information to the user and lists actions the user may take, such as ordering new batteries or obtaining disposal information. In some implementations, the electronic device 102 listens for a response from the user, such as a user selection of one or more of the listed actions, and responds accordingly (e.g., obtaining and audibly conveying disposal options to the user).

In some examples, the response 106 is based on data stored in a memory of the electronic device 102. According to some examples, the response 106 is based on one or more capabilities of the electronic device 102. In some examples, the response 106 is based on data stored remotely from the electronic device 102 (a remote server connected via a wireless communications link, the internet, etc.). In some examples, the response 106 is produced using only resources of the electronic device 102 (one or more processors of the electronic device 102, the memory of the electronic device 102, etc.), resources of a remote device, or both.

In aspects, the response 106 is based on one or more of a plurality of inferences generated by the LLM based on the input prompt 104. The plurality of inferences, in aspects, can be a plurality of virtual batches. The plurality of virtual batches can be generated from a dependency map, as outlined in this disclosure, including generating the virtual batches by logical extrapolation and not generating physical batches. The dependency map includes one or more index markers for each of a plurality of tokens and a correlation marker for each of the one or more index markers. The plurality of tokens, in aspects, are part of the generated plurality of inferences. The response 106 is based on one of the plurality of virtual batches, the one of the plurality of virtual batches selected by the LLM. In some examples, the LLM compares the plurality of virtual batches and bases the selection on the comparison. In some examples, the response 106 is based on more than one selection of the plurality of virtual batches. In some examples, operations are performed on the selected virtual batch, which transform it into the final form of the response 106.

### Example Devices

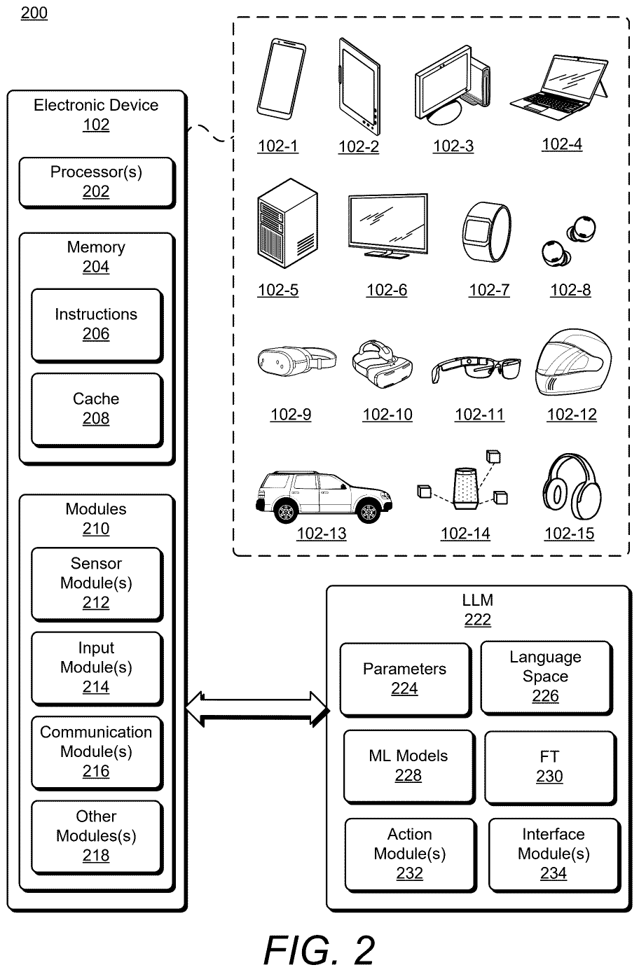

FIG. 2 illustrates an example of an electronic device 102 of FIG. 1 for implementing virtual batches in large language model inferences. Examples of the electronic device 102 include a smartphone 102-1, a tablet device 102-2, a desktop computer 102-3, a laptop computer 102-4, a server 102-5 (including a server array), a smart monitor or TV 102-6, a smartwatch 102-7, earbuds (e.g., true-wireless earbuds) 102-8, VR goggles 102-9, an AR headset 102-10, smart-glasses 102-11, a smart-helmet 102-12, a smart vehicle 102-13, a home hub device 102-14, and headphones 102-15. Although not shown, the electronic device 102 may also be implemented as any of a mobile communication device, a client device, a home automation and control system, an entertainment system, a personal media device, a health monitoring device, a drone, a camera, an Internet home appliance capable of wireless Internet access and browsing, an IoT device, security systems, and the like. Note that the electronic device 102 can be wearable, non-wearable but mobile, or relatively immobile (e.g., appliances). The electronic device 102 may include components or interfaces omitted from FIG. 2 for the sake of clarity or visual brevity.

As illustrated, the electronic device 102 includes one or more processors 202 and a memory 204 (e.g., a computer-readable medium). The one or more processors 202 may include any suitable single-core or multi-core processor (an application processor (AP), a digital-signal processor (DSP), a central processing unit (CPU), a graphics processing unit (GPU), etc.). The one or more processors 202 may be configured to execute instructions or commands stored within the memory 204. The memory 204 may be stored within one or more non-transitory storage devices (e.g., a random access memory (RAM, dynamic RAM (DRAM), non-volatile RAM (NVRAM), static RAM (SRAM), etc.), a read-only memory (ROM), a flash memory, a hard drive, a solid-state drive (SSD), or any type of media suitable for storing electronic instructions), each coupled with a computer system bus. The term “coupled” may refer to two or more elements that are in direct contact (physically, electrically, magnetically, optically, etc.) or to two or more elements that are not in direct contact with each other but still cooperate and/or interact with each other.

The memory 204, in some examples, includes instructions 206. The instructions 206 can be in the form of executable code, one or more applications, software, etc. In some examples, the memory 204 further includes a cache 208. According to some examples, the cache 208 is a virtual memory partition of the memory 204. In some examples, the cache 208 is a physical partition of the memory 204.

The electronic device 102 includes, in some examples, one or more modules 210. The modules 210 can, in aspects, be based on one or more capabilities of the electronic device 102. Examples of the modules 210 include one or more sensor modules 212, one or more input modules 214, one or more communication modules 216, and one or more other modules 218. The one or more sensor modules 212 may include input sensors, capacitive sensors, infrared sensors, or optical sensors. Data based on any one of the one or more sensor modules 212 may be used in parsing an input (e.g., the prompt input 104 of FIG. 1), as a basis for a generated output (e.g., the response 106 of FIG. 1), as an action for the output, as the input or a part of the input, or as any other aspect of virtual batches in large language model inferences. Similarly, data based on any one of the one or more input modules 214 may be used in parsing an input (e.g., the prompt input 104 of FIG. 1), as a basis for a generated output (e.g., the response 106 of FIG. 1), as an action for the output, as the input or a part of the input, or as any other aspect of virtual batches in large language model inferences.

The one or more communication modules 216 may include wired or wireless connection interfaces, radios, connection protocols, etc. The one or more other modules 218 may include other aspects of the electronic device 102 not shown for clarity (e.g., a screen, a microphone, or other capabilities of the electronic device 102). The one or more communication modules 216, the one or more other modules 218, or both may also be used in parsing an input (e.g., the prompt input 104 of FIG. 1), as a basis for a generated output (e.g., the response 106 of FIG. 1), as an action for the output, as a basis for the input or a part of the input, or as any other aspect of virtual batches in large language model inferences. The one or more communication modules 216 may enable communication of device data (e.g., received data, transmitted data, or other information as described herein) and may provide connectivity to one or more networks and other devices connected therewith. Examples of the one or more communication modules 216 include near field communications (NFC) transceivers, wireless personal area network (WPAN) radios compliant with various IEEE 902.15 (Bluetooth®) standards, wireless local area network (WLAN) radios compliant with any of various IEEE 902.11 (WiFi®) standards, wireless wide area network (WWAN) (3GPP-compliant) radios for cellular telephony, wireless metropolitan area network (WMAN) radios compliant with various IEEE 902.16 (WiMAX®) standards, infrared (IR) transceivers compliant with an Infrared Data Association (IrDA) protocol, and wired local area network (LAN) Ethernet transceivers. Device data communicated over the one or more communication modules 216 may be packetized or framed depending on a communication protocol or standard by which the electronic device 102 is communicating. The one or more communication modules 216 may include interfaces for communication over a local network, a private network, an intranet, the Internet, or wireless networks (e.g., WLANs, cellular networks, or WPANs).

The electronic device 102 may further include and/or be operatively coupled to an LLM 222. For example, the LLM 222 may be stored on the memory 204 (e.g., as part of the instructions 206). In another example, the LLM 222 is stored remote from the electronic device 102 and is accessed via the one or more communication modules 216. The LLM 222 includes one or more of parameters 224, a language space 226, machine-learned (ML) models 228, fine-tuning (FT) 230, one or more action modules 232, and one or more interface modules 234.

In aspects, the parameters 224 govern the behavior of the LLM 222. For example, the LLM 222 may take a prompt as an input (e.g., the input prompt 104 of FIG. 1). The LLM 222, in aspects, can parse the input using the parameters 224 and the language space 226. In some examples, the LLM 222 also uses ML models 228 to further parse the input and/or generate the output. In some examples, the LLM 222 uses the FT 230. For example, the FT 230 can be used to grant a generic LLM specialized knowledge pertaining to a particular subject. As an example, the FT 230 can include user-specific data. In some examples, the FT 230 includes one or more low-rank adaptations (LoRA), retrieval-augmented generations (RAG), or other techniques known in the art for fine-tuning or otherwise modifying existing LLMs (e.g., the LLM 222).

The one or more action modules 232 may allow the LLM 222 to execute actions. For example, if the parsing of the input indicates a desire to execute an action, the LLM 222 can use the one or more action modules 232 to execute the desired action. For example, consider a user input prompt of “cancel my meeting tomorrow.” The LLM 222 may parse the user input prompt (using the parameters 224, language space 226, etc.) and conclude that user calendar data is required to fully parse the user input prompt and generate the output. The one or more action modules 232 may include calendar functionality from the electronic device 102 and can provide the user calendar data to the LLM 222. The LLM 222 may further parse the user calendar data and conclude that a particular meeting is the “my meeting” referenced by the user. The one or more action modules 232 may cancel the particular meeting and provide a cancellation confirmation to the LLM 222. The LLM 222 may use the cancellation confirmation as at least a partial basis for the output. For example, the output can be of the form “I have canceled your meeting with the builder tomorrow. Is there anything else you need?”

Other actions may be accessible to the one or more action modules 232, including vehicle controls, information retrieval, communications, capabilities of the electronic device 102 (e.g., the modules 210), and similar actions. In some examples, the one or more action modules 232 use application programming interface (API) functionality from one or more applications available to the electronic device 102 or another device. In some examples, the LLM 222 can create a new action module based on known or implied capabilities. It should be understood that the one or more action modules 232 listed here, including the associated actions, are meant to be examples and should not be seen as limiting. Other actions and/or action modules 232 not listed can be equally employed by the LLM 222 using the methods outlined in this disclosure.

The one or more interface modules 234, in aspects, provide for interfacing between the LLM 222 and other devices, bots, etc. For example, the LLM 222 can use the one or more interface modules 234 to connect with a different LLM that is deployed on a remote device. For example, the different LLM may have access to restricted data that the LLM 222 cannot access itself. In another example, the one or more interface modules 234 can import sensor data from the one or more sensor modules 212 of the electronic device 102. For example, the LLM 222 can, using the one or more interface modules 234, obtain a user facial expression for use as at least part of the input, the user facial expression based on camera data from a camera of the one or more input modules 214.

### Example Dependency Map

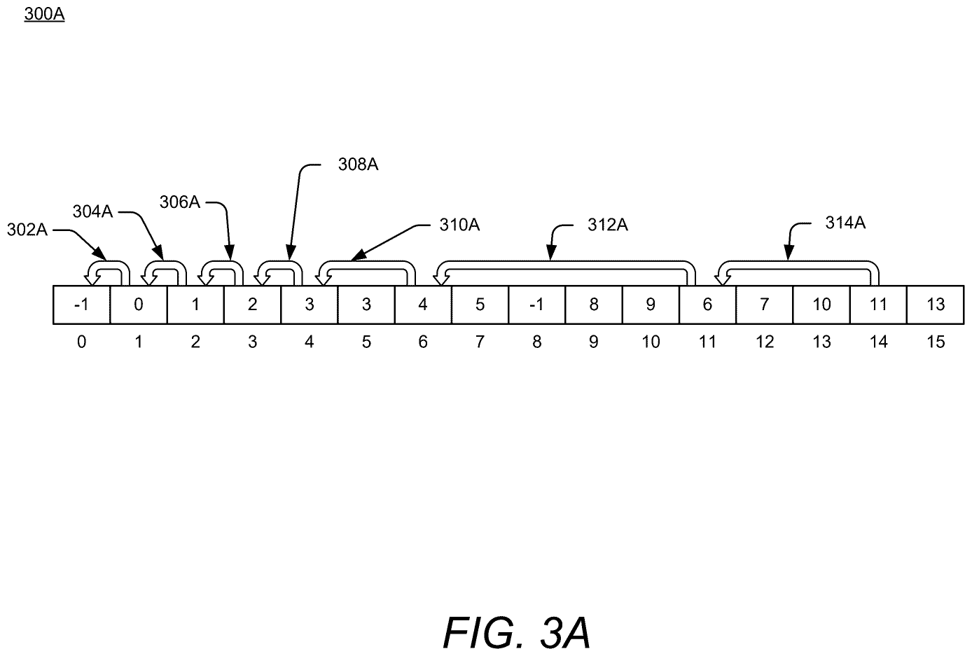

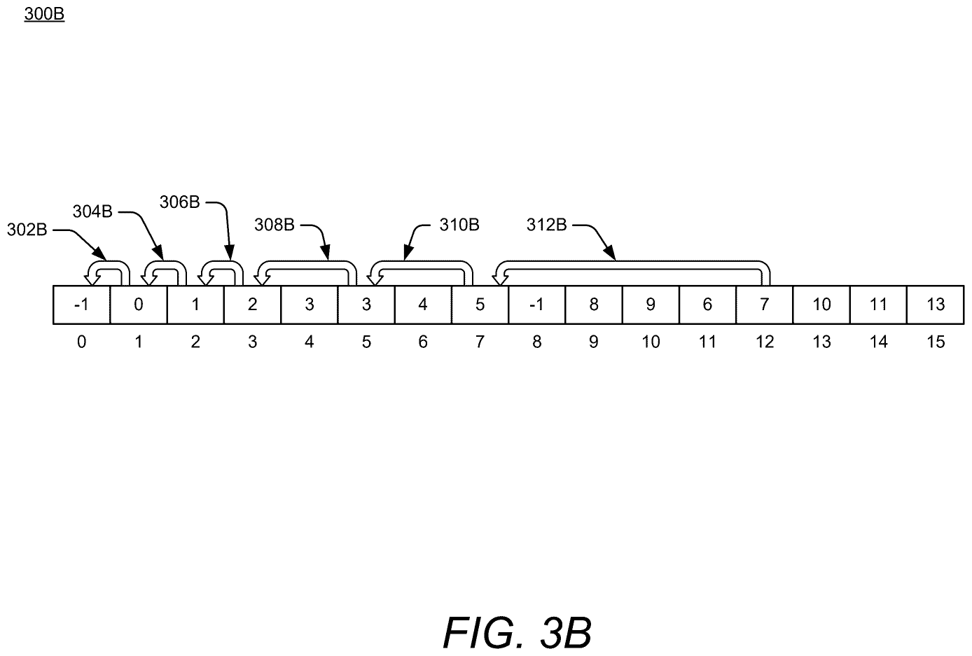

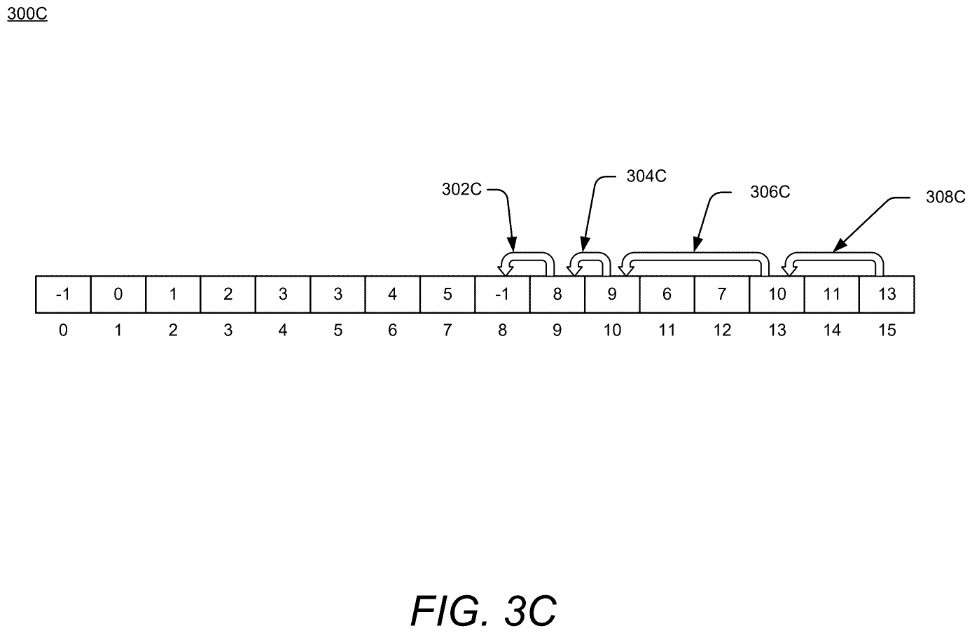

FIG. 3A illustrates an example dependency map array 300A for implementing virtual batches in large language model inferences. The dependency map array 300A has indices 0 through 15, each with an associated correlation value. In aspects, the indices and the correlation values can be represented by ordinal pairs. For example, the index 0 has the correlation value of −1, which can be represented by the ordinal pair (0, −1).

In aspects, the dependency map array 300A maps dependencies of a plurality of tokens of an inference made by an LLM (e.g., the LLM 222 of FIG. 2). The dependency map array 300A can be used to generate an output from the LLM (e.g., the response 106 of FIG. 1). Each of the indices denotes where a token of the plurality of tokens is located on the dependency map array 300A, and each of the correlation values denotes the index of a preceding token to the token of the plurality of tokens.

The index 0 of the dependency array 300A includes, as outlined prior, the ordinal pair (0, −1). The −1 correlation value shows that a token indicated by index 0 has no antecedent and is a beginning of a first virtual batch. The index 1 includes an ordinal pair (1, 0), indicating a token indicated by the index 1 attends to the token indicated by the index 0. A first association arrow 302A shows a mapping from the index 1 (ordinal pair (1, 0)) to the index 0. The index 2 includes an ordinal pair (2, 1), indicating a token indicated by the index 2 attends to the token indicated by the index 1. A second association arrow 304A shows a mapping from the index 2 to the index 1. The index 3 includes an ordinal pair (3, 2), indicating a token indicated by the index 3 attends to the token indicated by the index 2. A third association arrow 306A shows a mapping from the index 3 to the index 2. The index 4 includes an ordinal pair (4, 3), indicating a token indicated by the index 4 attends to the token indicated by the index 3. A fourth association arrow 308A shows a mapping from the index 4 to the index 3.

It should be noted that, while the token indicated by the index 1 is said to attend to the token indicated by the index 0, this does not mean that the token indicated by the index 1 exclusively attends to the token indicated by the index 0. As used in this disclosure, attending by a first token to a second token may include the first token attending to itself and/or attending to any token, which the second token attends to. For example, if the second token attends to a third token, which in turn attends to a fourth token, the first token can attend to one or more of the first, second, third, and fourth tokens. An association arrow (e.g., the first association arrow 302A) indicates the attending of one token to another (e.g., the first association arrow 302A shows the token indicated by the index 1 attends to the token indicated by the index 0).

The index 6 has an ordinal pair (6, 4), which indicates a token associated with the index 6 attends to the token associated with the index 4, as shown by a fifth association arrow 310A. Similarly, the index 11 has an ordinal pair (11, 6), which indicates a token associated with the index 11 attends to the token associated with the index 6, as shown by a sixth association arrow 312A. Similarly, the index 14 has an ordinal pair (14, 11), which indicates a token associated with the index 14 attends to the token associated with the index 11, as shown by a seventh association arrow 314A. A first ordered set of attending tokens, in this example, is {0, 1, 2, 3, 4, 6, 11, 14}. The first ordered set, in some examples, is a first terminal chain of tokens (e.g., a complete first virtual batch). In other examples, the first ordered set is part of an incomplete first virtual batch and has future tokens, which will attend to a token associated with the index 14.

FIG. 3B shows a virtual batch mapping using a dependency array 300B. The dependency array 300B is the same as the dependency array 300A of FIG. 3A, but a different virtual batch path is shown in FIG. 3B from that of FIG. 3A. As in the example of FIG. 3A, the index 0 includes an ordinal pair (0, −1). The index 1 includes an ordinal pair (1, 0), indicating a token indicated by the index 1 attends to the token indicated by the index 0. A first association arrow 302B shows a mapping from the index 1 (ordinal pair (1, 0)) to the index 0. A second association arrow 304B shows a mapping from the index 2 to the index 1, and a third association arrow 306B shows a mapping from the index 3 to the index 2.

The index 5, similar to the index 4, has the correlation value 3, giving it an ordinal pair (5, 3). A fourth association arrow 308B shows a mapping from the index 5 to the index 3. The index 7 has an ordinal pair (7, 5), which indicates a token associated with the index 7 attends to the token associated with the index 5, as shown by a fifth association arrow 310B. Similarly, the index 12 has an ordinal pair (12, 7), which indicates a token associated with the index 12 attends to the token associated with the index 7, as shown by a sixth association arrow 312B. A second ordered set of attending tokens, in this example, is {0, 1, 2, 3, 5, 7, 12}. The second ordered set, in some examples, is a second terminal chain of tokens (e.g., a complete second virtual batch). In other examples, the second ordered set is part of an incomplete second virtual batch and has future tokens, which will attend to the token associated with the index 12.

Consider, for example, the first ordered set of FIG. 3A and the second ordered set. Note that both have a same prefix, namely {0, 1, 2, 3}. As shown in these examples, it is possible for two or more virtual batches to share the same prefix. In other examples, two or more virtual batches can share a same portion (shown in the examples of FIGS. 3A and 3B as a prefix), e.g., a middle portion, a terminal portion, or any combination of portions. The generation of virtual batches using a dependency map (the dependency array 300B, the dependency array 300A of FIG. 3A, etc.) allows for a smaller storage and computational footprint than physical batching.

FIG. 3C shows a virtual batch mapping using a dependency array 300C. The dependency array 300C is the same as the dependency array 300A of FIGS. 3A and 300B of FIG. 3B, but a different virtual batch path is shown in FIG. 3C from those of FIG. 3A and FIG. 3B. The index 8 includes an ordinal pair (8, −1). The ordinal pair (8, −1) indicates the token associated with the index 8 does not attend to any other token associated with the dependency array 300C (though, for example, another token not indicated by the dependency array 300C can, in some examples, be of the same form as one or more of the plurality of tokens, but the same form is incidental and not part of the logical construct of the dependency array 300C). The index 9 includes an ordinal pair (9, 8), indicating a token indicated by the index 9 attends to the token indicated by the index 8. A first association arrow 302C shows a mapping from the index 9 to the index 8. A second association arrow 304C shows a mapping from the index 10 to the index 9, a third association arrow 306C shows a mapping from the index 13 to the index 10, and a fourth association arrow 308C shows a mapping from the index 15 to the index 13.

A third ordered set of attending tokens, in this example, is {8, 9, 10, 13, 15}. The third ordered set, in some examples, is a third terminal chain of tokens (e.g., a complete third virtual batch). In other examples, the third ordered set is part of an incomplete third virtual batch and has future tokens, which will attend to a token associated with the index 15. The third ordered set does not attend to any of the tokens associated with the first ordered set in the example of FIG. 3A or the second ordered set in the example of FIG. 3B (again, other than incidentally should two tokens happen to have the same form).

It should be noted that, while a dependency map in the form of the dependency map array 300A of FIG. 3A, 300B of FIG. 3B, and/or 300C of FIG. 3C has been illustrated in FIGS. 3A, 3B, and 3C as an array of ordinal pairs, this need not be the case. The dependency map can equivalently be a 1-dimensional array of single values (e.g., with the indices implicit), a matrix of greater-than-two-dimensional correlations (e.g., triplets), etc. The dependency map arrays 300A, 300B, and/or 300C are used for ease of illustrating the concept of the dependency map and should not be seen as limiting. In some examples, though the dependency map is ordered, an order of the dependency map need not indicate a corresponding order in a memory where the dependency map is stored (e.g., a key-value (KV) cache).

### Example Virtual Batches

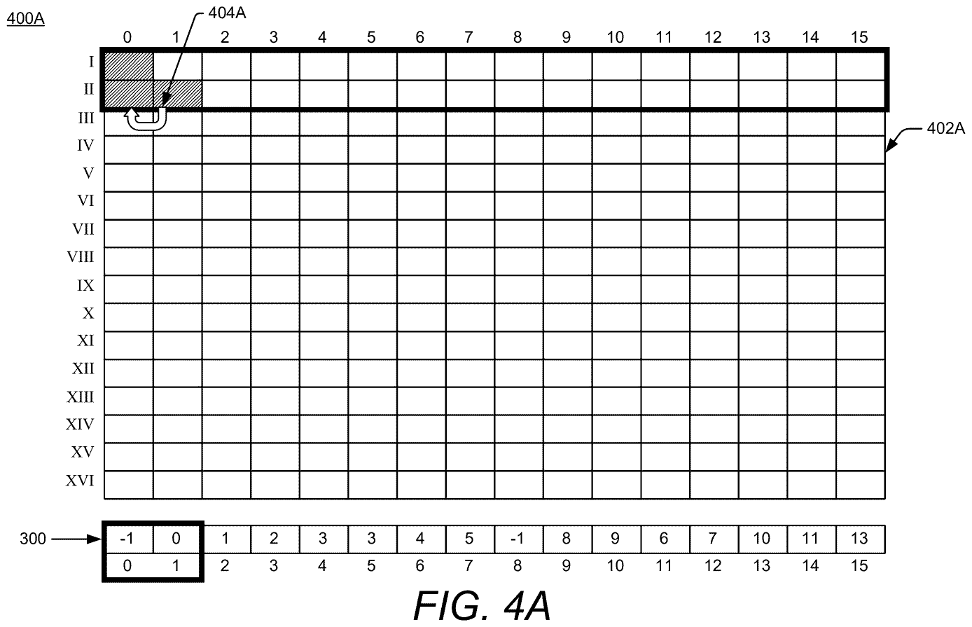

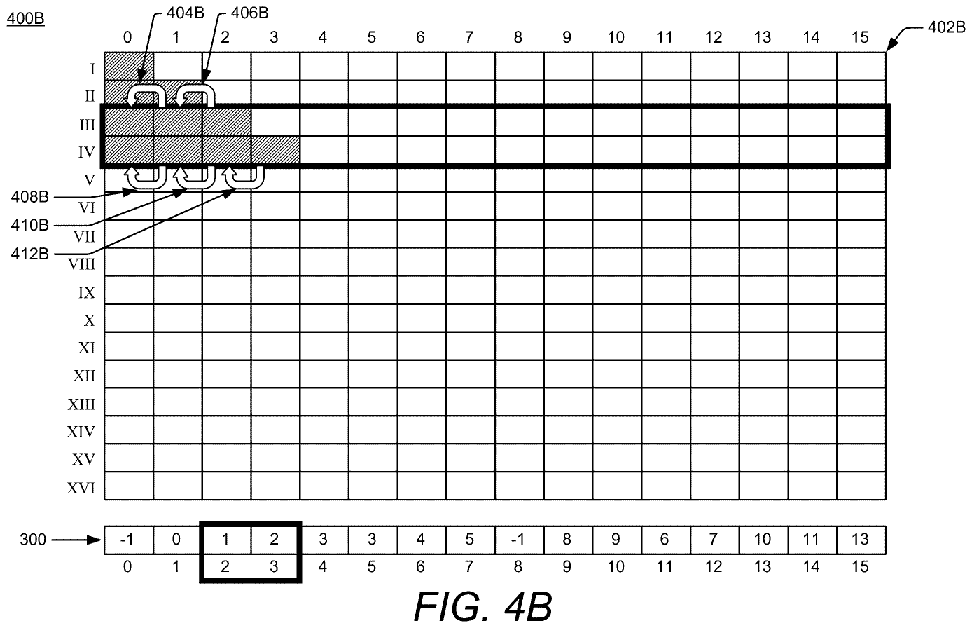

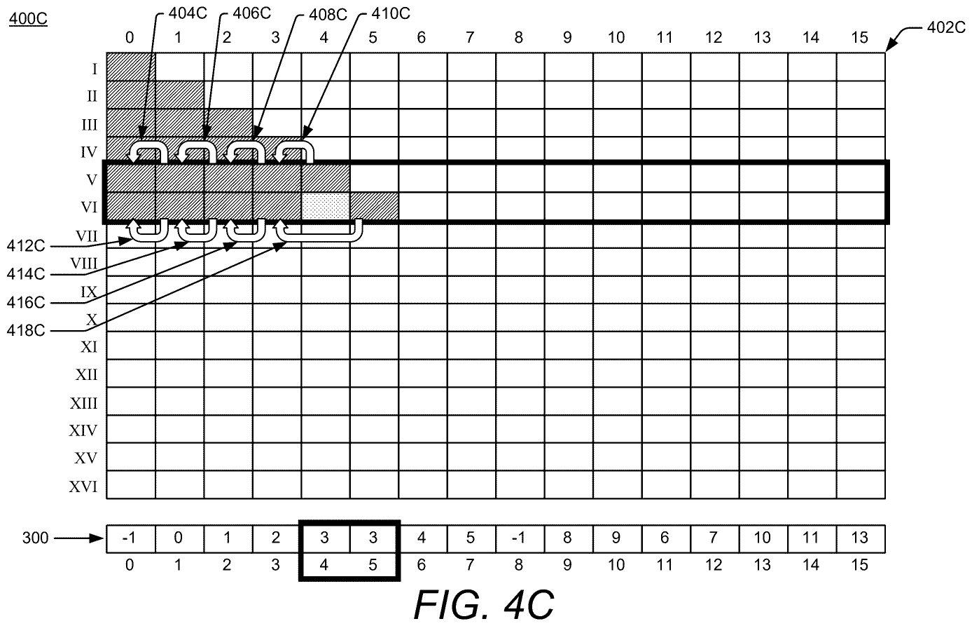

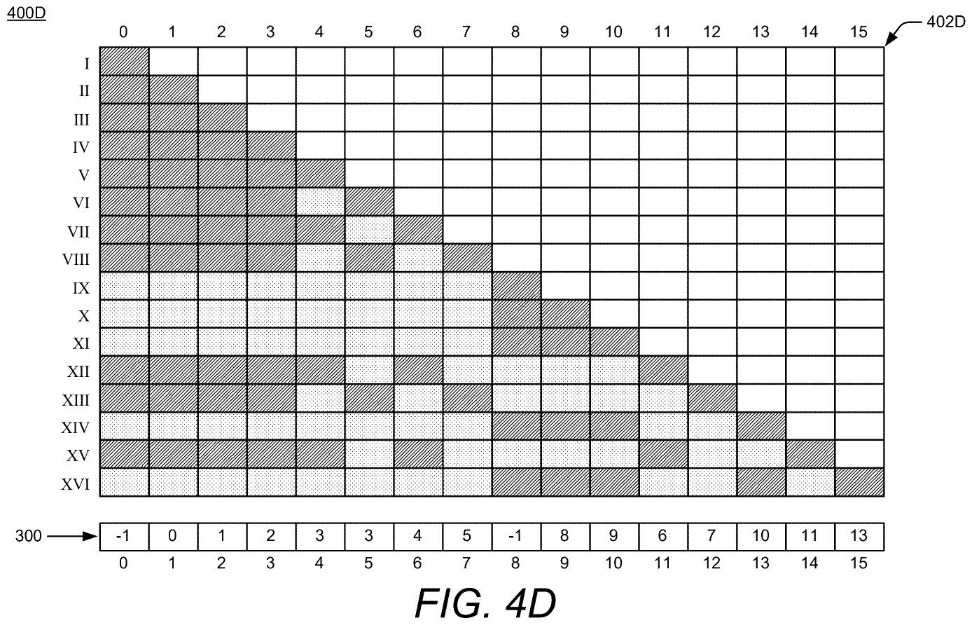

FIGS. 4A-4D illustrates example virtual batch generations 400A-400D with masking. The virtual batch generations 400A-400D can, in aspects, be generated from a dependency map (e.g., the dependency map arrays 300A-300C of FIGS. 3A-3C). In some examples, a dependency map can be generated from the virtual batch generations 400A-400D. In some examples, the virtual batch generations 400A-400D are generated implicitly from the dependency map, without the creation of any physical virtual batches. It should be noted that, though the example virtual batch generations 400A-400D may suggest they proceed row by row in sequential order, this need not be the case. This is shown for ease of understanding and not as a limitation. Any row shown in any of the virtual batch generations 400A-400D may be generated in any order. Further, the virtual batch generations 400A-400C show two row generations at a time. This also is shown for ease of understanding and not as a limitation. Other numbers of simultaneous row generations may equally be used without diverging from the base concept, such as 16 rows, 32 rows, or 1 row.

FIG. 4A illustrates the example virtual batch generation 400A. The virtual batches are shown in a grid 402A marked by numerical columns 0-15 and Roman numerical rows I-XVI. The columns 0-15 correspond to the indices 0-15 of a dependency map array 300 (shown as the same dependency array as the dependency arrays 300A-300C of FIGS. 3A-3C). Rows and columns of the grid 402A will be referred to by an ordinal pair. For example, consider row I column 0 of the grid 400A. An ordinal pair for this row and column combination is (I, 0). The ordinal pair (I, 0) of the grid 402A is shaded in diagonal lines, showing that the ordinal pair (I, 0) of the grid 402A is active. An ordinal pair (II, 1) of the grid 402A has a corresponding attention arrow 404A. The attention arrow 404A shows that the ordinal pair (II, 1) attends to an ordinal pair (II, 0). In aspects, it can be understood as the row II corresponding to an attention mask when processing the token at index 1. Specifically, a token associated with the index 1 in the dependency map array 300 attends to a token associated with the index 0, thus cells indicated by the ordinal pairs (II, 0) and (II, 1) are active (non-masked).

FIG. 4B illustrates an example virtual batch generation 400B, which is a continuation of the example virtual batch generation 400A of FIG. 4A. Rows III and IV of a grid 402B (which, in aspects, is a continuation of the grid 400A of FIG. 4A) are filled. An attention arrow 404B shows that an ordinal pair (III, 1) attends to an ordinal pair (III, 0), which, in aspects, shows the token associated with the index 1 in the dependency map array 300 attends to the token associated with the index 0. An attention arrow 406B shows that an ordinal pair (III, 2) attends to an ordinal pair (III, 1), which, in aspects, shows the token associated with the index 2 in the dependency map array 300 attends to the token associated with the index 1. An attention arrow 408B shows that an ordinal pair (IV, 1) attends to an ordinal pair (IV, 0), which, in aspects, shows the token associated with the index 1 in the dependency map array 300 attends to the token associated with the index 0. An attention arrow 410B shows that an ordinal pair (IV, 2) attends to an ordinal pair (IV, 1), which, in aspects, shows the token associated with the index 2 in the dependency map array 300 attends to the token associated with the index 1. An attention arrow 412B shows that an ordinal pair (IV, 3) attends to an ordinal pair (IV, 2), which, in aspects, shows the token associated with the index 3 in the dependency map array 300 attends to the token associated with the index 2.

The example virtual batch generations 400A and 400B do not have any masked ordinal pairs. Considering the ordinal pairs of the dependency map array 300 in the form of (index, correlation value), the ordinal pairs (0, −1) through (4, 3) show an ordered index set of {0, 1, 2, 3, 4} with a corresponding ordered correlation value set of {−1, 0, 1, 2, 3}. FIG. 4C illustrates an example virtual batch generation 400C, which is a continuation of the example virtual batch generations 400A and 400B of FIGS. 4A and 4B, respectively. Consider the ordinal pair (5, 3) of the dependency map array 300. The correlation value 3 is the same as the correlation value in the ordinal pair (4, 3) of the dependency map array 300. This will change the behavior of the virtual batch generation 400C vs those of 400A and 400B.

Rows V and VI of a grid 402C (which, in aspects, is a continuation of the grids 402A and 402B of FIGS. 4A and 4B, respectively) are filled. An attention arrow 404C shows that an ordinal pair (V, 1) attends to an ordinal pair (V, 0), which, in aspects, shows the token associated with the index 1 in the dependency map array 300 attends to the token associated with the index 0. An attention arrow 406C shows that an ordinal pair (V, 2) attends to an ordinal pair (V, 1), which, in aspects, shows the token associated with the index 2 in the dependency map array 300 attends to the token associated with the index 1. An attention arrow 408C shows that an ordinal pair (V, 3) attends to an ordinal pair (V, 2), which, in aspects, shows the token associated with the index 3 in the dependency map array 300 attends to the token associated with the index 2. An attention arrow 410C shows that an ordinal pair (V, 4) attends to an ordinal pair (V, 3), which, in aspects, shows the token associated with the index 4 in the dependency map array 300 attends to the token associated with the index 3. This completed the ordered index set of {0, 1, 2, 3, 4} corresponding with the ordered correlation value set of {−1, 0, 1, 2, 3}.

An attention arrow 412C shows that an ordinal pair (VI, 1) attends to an ordinal pair (VI, 0), which, in aspects, shows the token associated with the index 1 in the dependency map array 300 attends to the token associated with the index 0. An attention arrow 414C shows that an ordinal pair (VI, 2) attends to an ordinal pair (VI, 1), which, in aspects, shows the token associated with the index 2 in the dependency map array 300 attends to the token associated with the index 1. An attention arrow 414C shows that an ordinal pair (VI, 3) attends to an ordinal pair (VI, 2), which, in aspects, shows the token associated with the index 3 in the dependency map array 300 attends to the token associated with the index 2.

An attention arrow 418C shows that an ordinal pair (VI, 5) attends to an ordinal pair (VI, 3), which, in aspects, shows the token associated with the index 5 in the dependency map array 300 attends to the token associated with the index 3. It should be noted that an ordinal pair (VI, 4) is not shown to attend to anything, making this a masked ordinal pair (as denoted by the dotted fill). In aspects, a masked ordinal pair indicates the token corresponding to the index of the column is not actively referenced by the corresponding virtual batch. Consider, for example, two virtual batches constructed from the active cells of rows V and VI. The row V, in this example, is a virtual batch of the tokens associated with the ordered indices {0, 1, 2, 3, 4} and row VI is a virtual batch of the tokens associated with the ordered indices {0, 1, 2, 3, 5}.

FIG. 4D illustrates an example virtual batch generation 400D for the entirety of the dependency map array 300, including all masking. The example dependency map array 300 has two indices with corresponding correlation values −1 (the index 0 and the index 8), which means, in this example, there must be at least two virtual batches as the correlation value −1 shows no dependency/attention. It is possible for there to be more than one virtual batch starting from a same −1 correlation value, as is the case in a grid 402D showing all of the virtual batches for the dependency map array 300. Consider, for example, rows XIII and XV. The row XIII has a set of first non-masked indices {0, 1, 2, 3, 5, 7, 12} and the row XV has a set of second non-masked indices {0, 1, 2, 3, 4, 6, 11, 14}. By associating the non-masked indices with the corresponding tokens from the dependency map array 300, two virtual batches are generated. A row XVI also contains a virtual batch, represented by a third set of non-masked indices {8, 9, 10, 13, 15}.

Though the example of three virtual batches corresponding with the first, second, and third sets of non-masked indices has been shown, other virtual batch configurations are possible from the example dependency map array 300. For example, consider a row XI. The row XI can construct a fourth set of non-masked indices {8, 9, 10}, which, though a subset of the third set of non-masked indices, is still unique. In this way, it is possible, from the dependency map array 300, to generate 16 total virtual batches by taking the unique token sequences indicated by the active cells of each row. Further, more than 16 total virtual batches, in some examples, can be created from the dependency map 300 by taking partial portions of one or more of the rows, other novel combinations between different rows, etc. The examples shown are intended to aid in illustration of the concept, not to limit the scope of the concept. It should be noted that the construction of physical virtual batches (e.g., batches whose data are stored in a KV cache or other memory) is not necessary to construct the virtual batches as information for the virtual batches is stored in the dependency map array 300, which can be, in some examples where the indices are implicit, a 1D array with 16 members. In some examples, the virtual batches shown in FIG. 4D need not be complete as additional computing is still possible.

### Large Language Models (LLMs)

Generally, LLMs are a class of artificial intelligence (AI). LLMs (e.g., the LLM 222 of FIG. 2) are trained on enormous amounts of data to provide foundational capabilities, which can be used and reused, often through fine-tuning for particular applications and tasks. Other software applications, in contrast, are often built and trained on specific data for each use case. In this way, LLMs are considered a type of foundational model.

Some LLMs use a machine-learned (ML) computer model that can parse language and provide context-aware outputs, for example to mimic a human response. This mimic of a human response is typically to a prompt, for example from a user asking a question. The prompt “ask how to get to the train station in French,” for example, can be used as a prompt by which an LLM provides a translation service, namely a human response in the French language to the English language prompt.

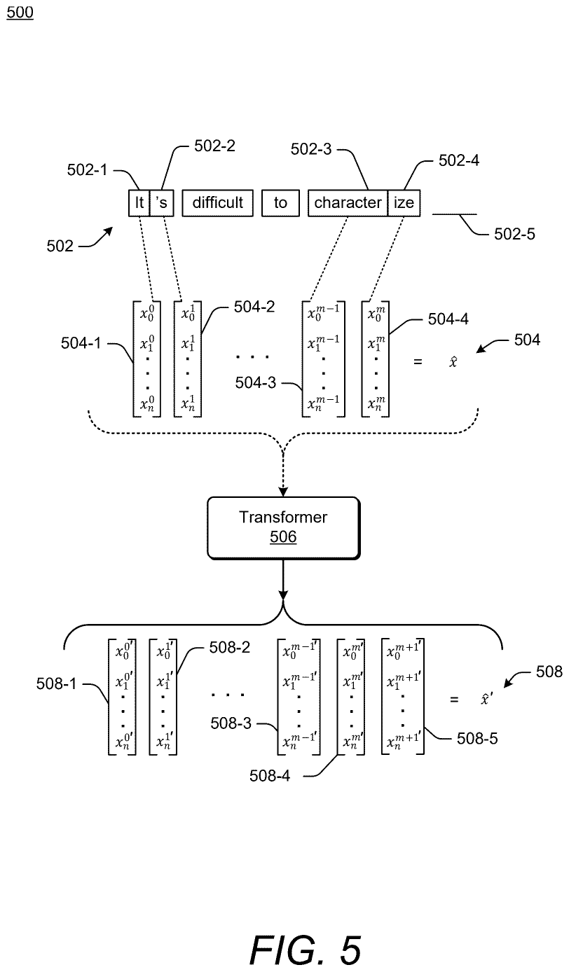

By way of example, consider FIG. 5, which illustrates a trainer 500 by which to train an LLM (e.g., the LLM 222 of FIG. 2) used for virtual batches in LLM inferences (e.g., the virtual batches 400 of FIG. 4). The trainer 500 receives training data as training inputs (e.g., an input 502). This training data may be of many different types (e.g., labeled text and prediction data). In the example illustrated by FIG. 5, the training input 502 is a phrase, though it may instead be a word, a long text passage (e.g., a book, article, or web-page), or any other data containing comprehensible text. In some examples, the text is from a screen or image capture. In a process called “tokenization,” the trainer 500 breaks the training input 502 into tokens, marked as tokens 502-1, 502-2, 502-3, and 502-4. Here, the training input 502 has a missing next word, marked as a blank 502-5. The goal of the trainer 500 is to predict the blank 502-5.

The trainer 500 encodes the tokens (502-1, 502-2, etc.) into an input tensor \hat{x} 504 through a mapping procedure. For instance, the token “It” 502-1 is mapped to a first component 504-1 of the input tensor \hat{x} 504, the token “'s” is mapped to a second component 504-2 of the input tensor \hat{x} 504, the token “character” is mapped to a third component 504-3 of the input tensor \hat{x} 504, and the token “ize” is mapped to a fourth component 504-4 of the input tensor \hat{x} 504. Though the tokens “It” 504-1 and “'s” 504-2 are shown as two portions of the word “It's,” other mapping schemes exist (e.g., mapping based on discrete words or phonemes). In some instances, an ML model or an ML component of the trainer 500 performs the tokenization and/or mapping of the training input 502 into the input tensor \hat{x} 504 (e.g., a feature-extracting convolutional neural network (CNN)). The mapping of the tokenized training input 502 into the input tensor \hat{x} 504 may involve a lookup table, which maps each possible token (e.g., 502-1, 502-2, etc.) to a known tensor object in a language space of the training data. The mapping of the tokens 502, in some examples, is referred to as an embedding.

A transformer 506 takes the input tensor \hat{x} 504 as an input, with the goal of predicting the blank 502-5 by transforming the input tensor \hat{x} 504 into a transformed tensor \hat{x}′ 508. The transformation process is mathematically represented as follows:

$$T \hat{x} = {\hat{x}}^{′} \qquad Eq . 1$$

T in Eq. 1 represents the transformer 506. The transformed tensor \hat{x}′ 508 includes components 508-1, 508-2, 508-3, 508-4, and 508-5. The component 508-1 is a transformation of the component 504-1 by the transformer 506 (similar for component pairs 508-2/504-2, 508-3/504-3, and 508-4/504-4). The component 508-5 corresponds to the blank 502-5, and thus the component 508-5 is a prediction for the blank 504-5. The final transformed tensor x′ 508 component 508-5 is derived as part of the transformation process in addition to the contextualization of the components 504-1 through 504-4.

In some examples, the final transformed tensor \hat{x}′ 508 component 508-5 is multiple components. For example, a second transformed tensor \hat{x}″ (not pictured) can be generated by performing a different transformation T′ (not pictured) as follows:

$${T}^{′} \hat{x} = {\hat{x}}^{″} \qquad Eq . 2$$

A plurality of transformed tensors (e.g., the final transformed tensor \hat{x}′, the second transformed tensor \hat{x}″) may be generated. The plurality of transformed tensors (e.g., the virtual batches 400 of FIG. 4), in some examples, can be compared by the LLM, and based on the comparison, one or more of the plurality of transformed tensors may be selected for output.

Inputs (e.g., the input tensor \hat{x} 504 and/or the training input 502) generally include multiple tokens. For instance, the training input 502 includes the tokens 502-1 through 502-4. The trainer 500 converts a single training input (e.g., the training input 502) into multiple training inputs. For example, by removing the token 502-4, the blank 502-5 “shifts left” as the training input 502 calls for the trainer 500 to predict the token 502-4, thus creating a new training input from the original training input 502. As the value for the token 502-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 500.

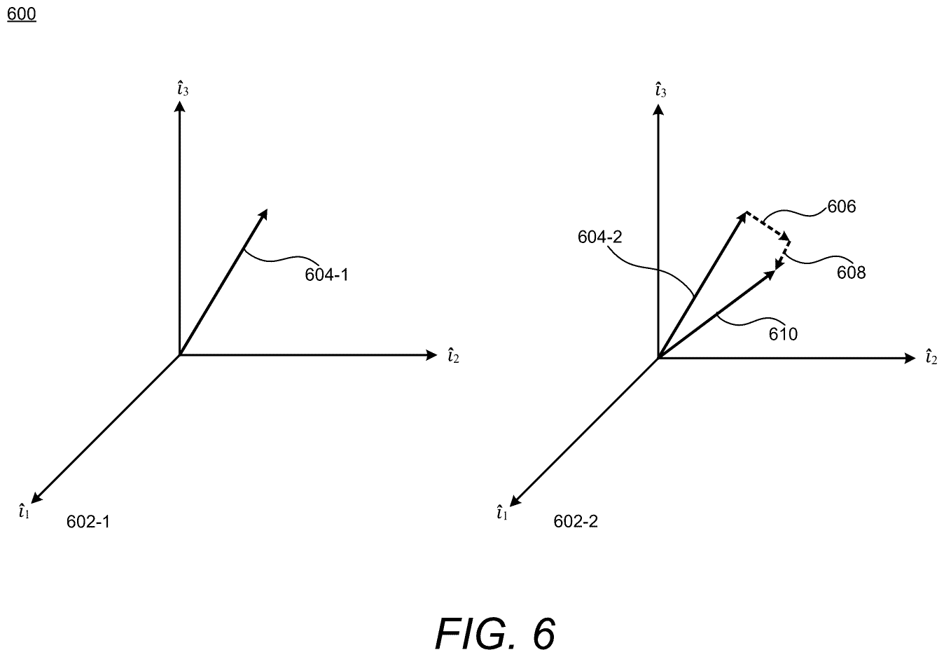

FIG. 6 illustrates an example transformation 600 in a language space 602-1 of an input tensor component 604-1 (e.g., the component 504-1 of the input tensor \hat{x} 504 of FIG. 5). The language space 602-1 is a multi-dimensional mathematical space, which includes specific language components codified as tensors within the multi-dimensional mathematical space. The term “tensor” is a mathematical object of any dimensionality, including scalar, vector, and matrix quantities. The language space 602-1 is therefore a mathematical vocabulary, and mapped tokens (e.g., token 502-1 of FIG. 5) are tokens that have been translated into the mathematical vocabulary. For ease of illustration, the language space 602-1 is shown in FIG. 6 as a three-dimensional space with orthogonal basis vectors î₁, î₂, and î₃. However, this should not be seen as limiting. In general, the language space 602-1 has the dimensionality of the mapped tokens from an input tensor. For example, the input tensor \hat{x} 504 of FIG. 5, whose tensor components 504-1 through 504-4 each contain n members, corresponds to an n-dimensional language space.

The input tensor component 604-1 is plotted in the language space 602-1, shown in FIG. 6 as a vector in three-dimensional space. In some examples, the plotting is the product of a lookup table, a CNN feature mapping, or any other mapping from a token into the language space 602-1. The input tensor component 604-1 is transformed by the transformation 600. Consider a language space 602-2, identical to the language space 602-1, and an input tensor component 604-2, identical to the input tensor component 604-1. The transformation 600 is based on transformation operators 606 and 608 and performed by a transformer. The transformation operators 606 and 608 are illustrated as vector addition operators, resulting in a remapped tensor 610.

As an illustration of this transformation, let the input tensor component 604-2 represent a mapped (e.g., translated into the mathematical vocabulary of the language space 602-2) token of “rodent” and let the transformation operators 606 and 608 be generated by contextualizing mapped tokens “large” and “eared” from an input prompt, which includes the phrase “large-eared rodent.” Contextualizing is defined as characterizing the correlations between “rodent,” “large,” and “eared” from the input prompt (e.g., the input 502 of FIG. 5) in a way that corresponds with how a speaker of the input prompt's language would understand the word “rodent” as it appears in the input prompt along with “large” and “eared.” In this illustration, the transformed tensor 610 maps to an area of the language space 602-2 containing the word “chinchilla.”

Though the transformation of the input tensor component 604-2 to the transformed tensor 610 has been shown as two transformations using the transformation operators 606 and 608, this should not be seen as limiting. Any number of transformation operations may be employed, including more than two or a single transformation operation. Transformation operators (e.g., the transformation operator 606) may also take forms other than vector/tensor addition, including, for example, multiplication (e.g., scaling, matrix multiplication, dot product, cross product, tensor product, etc.), normalization, orthogonalization, or any combination of these or other transformation operations known to a person of ordinary skill in the art. Thus, the transformation operators 606 and 608 of FIG. 6 are meant to be illustrative, not limiting.

### Example Methods

The method 700 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of computer program products (e.g., executable instructions stored on computer-readable storage memory that is local and/or remote to a computer processing system), and implementations can include software applications, programs, functions, and the like. Alternatively or in addition, any of the functionality described herein can be performed, at least in part, by one or more hardware logic components, for example, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

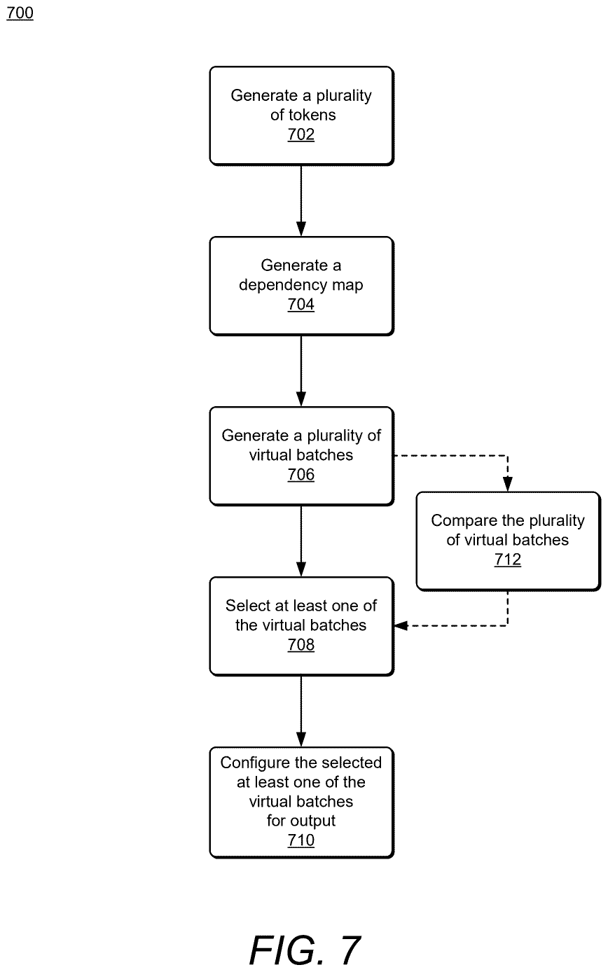

FIG. 7 illustrates an example method 700 for implementing virtual batches in large language model inferences. At 702, a plurality of tokens is generated by an LLM (e.g., the LLM 222). In some examples, the plurality of tokens includes inferences for an input (e.g., the input prompt 104). The inferences, in aspects, can be predictions based on the input. The input, in some examples, is one or more text inputs, one or more image inputs, one or more video inputs, one or more audio inputs, or a combination of any of these inputs.

At 704, a dependency map is generated by the LLM. In some examples, the dependency map includes one or more index markers for each of the plurality of tokens and a correlation marker for each of the one or more index markers. In some examples, the dependency map is a dependency array (e.g., the dependency map array 300A of FIG. 3A). In some examples, the dependency array includes ordinal pairs of the index markers and the correlation markers. In some examples, for each ordinal pair the correlation marker is less than the index marker. According to some examples, the correlation markers indicate index markers. The index markers, according to some examples, are determined by the positions of the correlation markers in the dependency array. According to some examples, the dependency array is linear.

At 706, a plurality of virtual batches (e.g., the example generated virtual batches 400C of FIG. 4C) is generated by the LLM. In aspects, the plurality of virtual batches are generated based on the dependency map. The plurality of virtual batches, for example, each include a discrete inference. In some examples, the plurality of virtual batches include a single physical batch of a batch length. According to some examples, the plurality of virtual batches include a plurality of physical batches, each of the plurality of physical batches having a final length, where the final lengths combine to the batch length. In some examples, the batch length is based on a size of a cache memory. In some examples, a first portion of a first batch of the plurality of virtual batches is the same as a second portion of a second batch of the plurality of virtual batches, and the first batch is different than the second batch.

In some examples, one or more of the plurality of virtual batches include one or more masked markers at one or more positions in the one or more of the plurality of virtual batches, the one or more masked markers configured to indicate the one or more positions in the one or more of the plurality of virtual batches are not correlated with any of the plurality of tokens. According to some examples, two or more of the plurality of virtual batches share a same input, the same input including a subset of the plurality of tokens. In some examples, two or more of the plurality of virtual batches share a first input and one or more other virtual batches of the plurality of virtual batches comprises a second input. The one or more other virtual batches is different than any of the two or more of the plurality of virtual batches and the first input is different than the second input. In some examples, the first input, the second input, or both are part of a previous input or part of another virtual batch.

At 708, one or more of the plurality of virtual batches is selected by the LLM. At 710, the selected at least one of the virtual batches is configured for output (e.g., the output 106 to the electronic device 102 of FIG. 1). For example, the at least one of the virtual batches can be processed using a module of an electronic device (e.g., the modules 210 of the electronic device 102 of FIG. 2). In some examples, the configuration is performed by an element of the LLM (the action modules 232 of the LLM 222 of FIG. 2, the interface modules 234 of the LLM 222, etc.). In some examples, the configuring of the selected at least one of the virtual batches for output includes using the selected at least one of the virtual batches as, at least in part, a second input for the LLM or for another LLM. According to some examples, the output is one or more of an action, an answer, information, a correspondence, or a suggestion.

At 712 and proceeding from 706, the plurality of virtual batches are compared by the LLM. For example, each of the plurality of virtual batches can be given a fitness score or value, and the fitness scores or values can be compared. In another example, one or more subsequent batches can be produced and the plurality of virtual batches compared based on a compatibility with the one or more subsequent batches. In some examples, the comparing of the virtual batches includes generating a plurality of fitness scores, with each of the plurality of virtual batches associated with one or more of the plurality of fitness scores. The method 700 proceeds from 712 to 708.

Throughout this disclosure, examples are described where a computing system (e.g., the computing device 102) may analyze information (e.g., the input prompt 104 of FIG. 1) associated with a user; for example, the input prompt 104 can be text from a messaging application (e.g., from an instantiated conversation application). Further to the descriptions above, the user may be provided with controls allowing the user to make an election as to both if and when systems, programs, and/or features described herein may enable collection of information (e.g., information about a user's social network, social actions, social activities, or profession, a user's preferences, a user's current location), and if the user is sent content or communications from a server. The computing system can be configured to only use the information after the computing system receives explicit permission from the user of the computing system to use the data. For example, in situations where an application of the computing system contains private messaging data used as the information, the user may be provided with an opportunity to provide input to control whether programs or features of the computing system can collect and make use of the information. Further, individual users may have constant control over what programs can or cannot do with the information. In addition, information collected may be pre-treated in one or more ways before it is transferred, stored, or otherwise used, so that personally identifiable information is removed. For example, the private messaging data can have personally identifying facets, names, and/or faces removed. Thus, the user may have control over whether information is collected about the user and a device of the user and how such information, if collected, may be used by the computing system and/or a remote computing system.

### Additional Examples

Various examples are described herein, including a first example method (example 1) that includes generating, with a large language model (LLM), a plurality of tokens. The method further includes generating, by the LLM, a dependency map including one or more index markers for each of the plurality of tokens and a correlation marker for each of the one or more index markers. The method further includes generating, based on the dependency map, a plurality of virtual batches, each of the plurality of virtual batches including a discrete inference. The method further includes selecting, by the LLM, one or more of the plurality of virtual batches as a final inference.

Example 2: The method of example 1, where the dependency map is a dependency array configured as ordinal pairs of the index markers and the correlation markers. For each ordinal pair, the correlation marker is less than the index marker.

Example 3: The method of example 2, where the index markers are determined by positions of the correlation markers in the dependency array.

Example 4: The method of example 3, where the dependency array is a linear array.

Example 5: The method of any one of the previous examples, where the plurality of virtual batches include a single physical batch of a batch length.

Example 6: The method of any one of examples 1 to 4, where the plurality of virtual batches include a plurality of physical batches, each of the plurality of physical batches having a final length, where the final lengths combine to a batch length.

Example 7: The method of any one of examples 5 or 6, where the batch length is based on a size of a cache memory.

Example 8: The method of any one of examples 5 or 6, where the batch length is dynamic.

Example 9: The method of example 1, where one or more of the plurality of virtual batches include one or more masked markers at one or more positions in the one or more of the plurality of virtual batches, the one or more masked markers configured to indicate the one or more positions in the one or more of the plurality of virtual batches are not correlated with any of the plurality of tokens.

Example 10: The method of any one of the previous examples, further including comparing, by the LLM, the plurality of virtual batches, where the selecting of the one or more of the plurality of virtual batches as the final inference configured for output is based at least in part on the comparison.

Example 11: The method of example 10, where the comparing of the plurality of virtual batches includes generating a plurality of fitness scores. Each of the plurality of virtual batches is associated with one or more of the plurality of fitness scores.

Example 12: The method of any one of the previous examples, where two or more of the plurality of virtual batches share a same input, the same input including a subset of the plurality of tokens.

Example 13: The method of any one of the previous examples, where the plurality of tokens are based on one or more text inputs, one or more image inputs, one or more video inputs, one or more audio inputs, or a combination of any of these inputs.

Example 14: The method of any one of the previous examples, where two or more of the plurality of virtual batches share a first input and one or more other virtual batches of the plurality of virtual batches comprises a second input. The one or more other virtual batches is different than any of the two or more of the plurality of virtual batches and the first input is different than the second input.

Example 15: The method of example 14, where the first input, the second input, or both are part of a previous input or part of another virtual batch.

Example 16: The method of any one of the previous examples, where a first portion of a first batch of the plurality of virtual batches is the same as a second portion of a second batch of the plurality of virtual batches, and the first batch is different than the second batch.

Example 17: The method of any one of the previous examples, further comprising configuring the selected at least one of the virtual batches for output.

Example 18: An electronic device including one or more processors and a memory storing instructions, which, when accessed by the one or more processors, cause the one or more processors to perform any one of the methods of examples 1-17.

Example 19: A non-transitory, computer-readable medium storing instructions, which, when accessed by one or more processors, cause the one or more processors to perform any one of the methods of examples 1-17.

Example 20: A computer program product including instructions, which, when accessed by one or more processors, cause the one or more processors to execute any one of the methods of examples 1-17.

### CONCLUSION

As used herein, a phrase referring to “at least one of” or “one or more of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of virtual batches in large language model inferences have been described in language specific to techniques and/or systems, it is to be understood that the subject of the appended claims is not necessarily limited to the specific techniques or methods described. Rather, the specific techniques and methods are disclosed as example implementations for virtual batches in large language model inferences.

What is claimed is:

1. A method comprising:
generating, with a large language model (LLM), a plurality of tokens;
generating, by the LLM, a dependency map comprising:
one or more index markers for each of the plurality of tokens; and
a correlation marker for each of the one or more index markers;
generating, based on the dependency map, a plurality of virtual batches, each of the plurality of virtual batches comprising a discrete inference; and
selecting, by the LLM, one or more of the plurality of virtual batches as a final inference.

2. The method of claim 1, wherein:
the dependency map is a dependency array configured as ordinal pairs of the index markers and the correlation markers; and
for each ordinal pair, the correlation marker is less than the corresponding index marker.

3. The method of claim 2, wherein the index markers are determined by positions of the correlation markers in the dependency array.

4. The method of claim 1, wherein:
one or more of the plurality of virtual batches comprise one or more masked markers at one or more positions in the one or more of the plurality of virtual batches; and
the one or more masked markers are configured to indicate the one or more positions in the one or more of the plurality of virtual batches are not correlated with any of the plurality of tokens.

5. The method of claim 1, wherein the plurality of virtual batches include a single physical batch of a batch length.

6. The method of claim 5, wherein the batch length is based on a size of a cache memory.

7. The method of claim 1, further comprising comparing, by the LLM, the plurality of virtual batches, wherein the selecting of the one or more of the plurality of virtual batches as the final inference is based at least in part on the comparison.

8. The method of claim 1, wherein:
two or more of the plurality of virtual batches share a first input;
one or more other virtual batches of the plurality of virtual batches comprises a second input;
the one or more other virtual batches is different than any of the two or more of the plurality of virtual batches; and
the first input is different than the second input.

9. An electronic device comprising:
one or more processors; and
a memory storing instructions, which, when accessed by the one or more processors, cause the one or more processors to:
generate, with a large language model (LLM), a plurality of tokens;
generate, by the LLM, a dependency map comprising:
one or more index markers for each of the plurality of tokens; and
a correlation marker for each of the one or more index markers;
generate, based on the dependency map, a plurality of virtual batches, each of the plurality of virtual batches comprising a discrete inference; and
select, by the LLM, one or more of the plurality of virtual batches as a final inference.

10. The electronic device of claim 9, wherein:
the dependency map is a dependency array configured as ordinal pairs of the index markers and the correlation markers; and
for each ordinal pair, the correlation marker is less than the corresponding index marker.

11. The electronic device of claim 10, wherein the index markers are determined by positions of the correlation markers in the dependency array.

12. The electronic device of claim 9, wherein:
one or more of the plurality of virtual batches comprise one or more masked markers at one or more positions in the one or more of the plurality of virtual batches; and
the one or more masked markers are configured to indicate the one or more positions in the one or more of the plurality of virtual batches are not correlated with any of the plurality of tokens.

13. The electronic device of claim 9, wherein the plurality of virtual batches include a single physical batch of a batch length.

14. The electronic device of claim 13, further comprising a cache memory, wherein the batch length is based on a size of the cache memory.

15. A non-transitory, computer-readable medium storing instructions, which, when accessed by one or more processors, cause the one or more processors to:
generate, with a large language model (LLM), a plurality of tokens;
generate, by the LLM, a dependency map comprising:
one or more index markers for each of the plurality of tokens; and
a correlation marker for each of the one or more index markers;
generate, based on the dependency map, a plurality of virtual batches, each of the plurality of virtual batches comprising a discrete inference; and
select, by the LLM, one or more of the plurality of virtual batches as a final inference.

16. The non-transitory, computer-readable medium of claim 15, wherein:
the dependency map is a dependency array configured as ordinal pairs of the index markers and the correlation markers; and
for each ordinal pair, the correlation marker is less than the corresponding index marker.

17. The non-transitory, computer-readable medium of claim 16, wherein the index markers are determined by positions of the correlation markers in the dependency array.

18. The non-transitory, computer-readable medium of claim 15, wherein:
one or more of the plurality of virtual batches comprise one or more masked markers at one or more positions in the one or more of the plurality of virtual batches; and
the one or more masked markers are configured to indicate the one or more positions in the one or more of the plurality of virtual batches are not correlated with any of the plurality of tokens.

19. The non-transitory, computer-readable medium of claim 15, wherein the plurality of virtual batches include a single physical batch of a batch length.

20. The non-transitory, computer-readable medium of claim 19, wherein the batch length is based on a size of a cache memory.
